(19) United States
(12) Patent Application Publication
(10) Pub. No.: US 2022/0314483 A1
(43) Pub. Date: Oct. 6, 2022

(54) COCONUT PUNCH TAP DRILLER

(71) Applicant: NC Coconut Company Limited, Damnernsaduak, Ratchabur (TH)

(72) Inventor: Mr. Narongsak CHUENSUCHON, Damnernsaduak,, Ratchabur (TH)

(73) Assignee: NC Coconut Company Limited, Damnernsaduak, Ratchabur (TH)

(21) Appl. No.: 17/413,557

(22) PCT Filed: May 11, 2021
(86) PCT No.: PCT/TH2021/000021

§ 371 Date: Jun. 13, 2021

(30) Foreign Application Priority Data
Mar. 30, 2021 (TH) 2103000952

(51) Int. Cl. B26F 1/32; A23N 1/00; A23N 5/03

(52) U.S. Cl. CPC B26F 1/32; A23N 1/00; A23N 5/03

(57) ABSTRACT

The coconut punch tap driller is composed of the 2-part casing (10) composed of a narrow section (20) that is cylindrically-shaped Tap 1 with a small diameter and sharp end made of plastic functioning to drill into the inside of the coconut (60). Next to the narrow section (20) is shaped into a flat section with a large diameter (30) functioning to distribute the weight of the upper impact force, so the narrow section (20) drills into the coconut (60). The flat section with the large diameter (30) is Tap 2. Next to the flat section with a large diameter (30) is the wide section (50) made from plastic with rectangle-shaped Tap 3 composed of Smooth Wall 1 (1), Smooth Wall 2 (2) and the Upper Smooth Wall (3). Tap 1, Tap 2 and Tap 3 are together on the same center, functioning as a space for inserting a straw (4) to drink coconut water.

### BRANCH OF SCIENCE ASSOCIATED WITH THE INVENTION

Engineering involving coconut punch tap drillers.

### BACKGROUND OF RELATED ART OR SCIENCE

In reference to Thai Design Patent No. 1802005071, the coconut drillers equipped with drills and taps to be used as drinking straws have a disadvantage in that drilling into the coconut requires pressure, not impact force, because the device was not designed to withstand impact force and turning force. Therefore, coconuts cannot be drilled in some cases. In addition, high-strength pressure has to be used at the drill point into the coconuts, which is not convenient for children or women. In this invention, the problem has been solved by making a portable, convenient and disposable coconut punch tap driller with a drill and tap for use as a drinking straw, but with ability to withstand impact force and turning force, which makes drilling convenient.

### INVENTION CHARACTERISTICS AND OBJECTIVES

The coconut punch tap driller is composed of a 2-part casing made of a narrow section serving as Tap 1 in a cylindrical shape with a small diameter and sharp end made from plastic. The function is to drill into the coconut. Next to the narrow section is flat-shaped with a large diameter functioning to distribute the weight of impact from the top, so the narrow section drills through to the coconut fruit. The center of the flat section with the large diameter is Tap 2. Next to the flat section with the large diameter is a wide area made from plastic that is rectangular-shaped Tap 3 composed of Smooth Wall 1 and Smooth Wall 2 with an upper smooth wall. Tap 1, Tap 2 and Tap 3 are together on the same center, functioning as a space for inserting a straw to drink the coconut water.

This invention is aimed at having a disposable, convenient and portable coconut punch tap driller with a drill and tap for use as a drinking straw, but one that is able to withstand the impact force and turning force, thereby making it convenient to drill.

### FULL DISCLOSURE OF INVENTION

FIG. 1, FIG. 2 and FIG. 3 show the parts of the coconut punch tap driller with the following characteristics:

The 2-part casing (10) composed of the narrow section (20) with cylindrically-shaped Tap 1 and a small diameter with a sharp or smooth end made of plastic or metal functions to drill into the inside of the coconut (60).

Next to the narrow section (20) is shaped into a flat section with a large diameter (30) functioning to distribute the weight of the impact force from the upper section, so the narrow section (20) drills into the coconut (60). The weld of the narrow section (20) and the flat section with a large diameter (30) is a thicker part (40) to build strength for receiving impact force from the upper section, so the narrow section (20) drills into the coconut (60). The round, flat section with a large diameter (30) is Tap 2.

Next to the round, flat section with a large diameter (30) is the wide section (50) made of plastic or metal is rectangle-shaped Tap 3 composed of Smooth Wall 1 (1). Smooth Wall 2 (2) and the Upper Smooth Wall (3). Smooth Wall 1 (1) and Smooth Wall 2 (2) function for the fingers to grasp and turn to drilling into the coconut (60). And the Upper Smooth Wall (3) functions to withstand the impact force to strengthen the narrow section (20) drilling into the coconut (60).

Once the narrow section (20) has drilled into the coconut (60), Tap 1, Tap 2 and Tap 3 that are placed on the same center, functioning as a space for inserting a straw (4) to drink coconut water.

The narrow section (20) and the wide section (50) may have either the same or different lengths.

### BRIEF DESCRIPTION OF DRAWINGS

FIG. 1 shows the parts of the coconut punch tap driller in this invention.

FIG. 2 shows the parts of the coconut punch tap driller in this invention.

FIG. 3 shows the parts of the coconut punch tap driller in this invention.

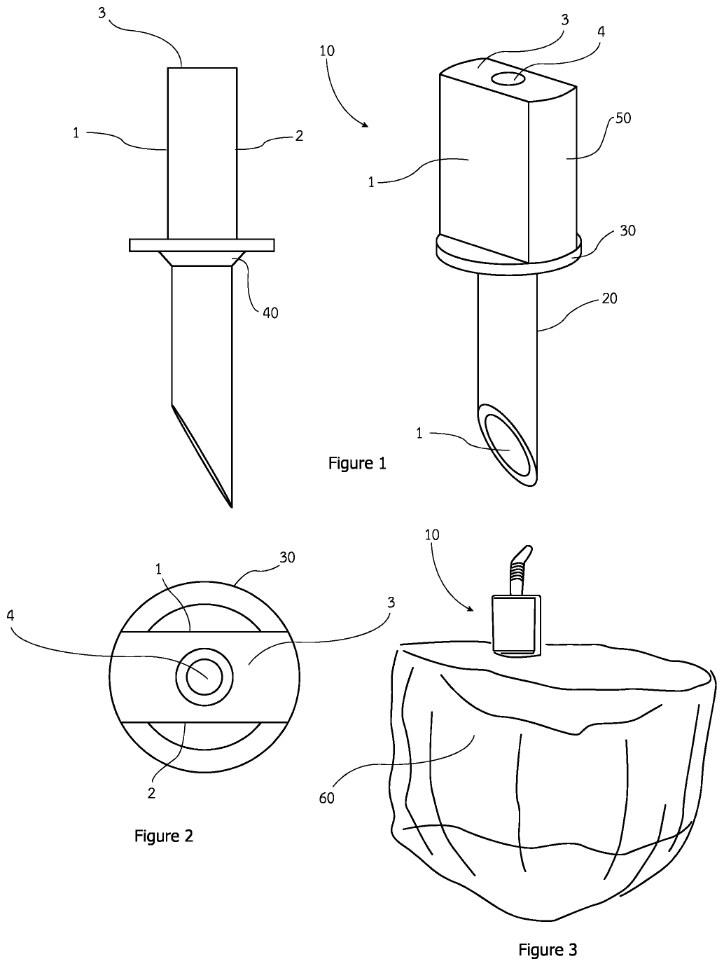

### BEST INVENTION METHOD

As mentioned in the section of the complete disclosure of the invention.

1. The coconut punch tap driller that is composed of a 2-part casing (10) composed of the following:
The narrow section (20) that is cylindrically-shaped Tap 1 with a small diameter has a 5 sharp end made of plastic functioning to drill into the inside of the coconut (60).
This invention has the following special characteristics:
Next to the narrow section (20) is shaped into a flat section with a large diameter (30) functioning to distribute the weight of impact from the upper section, so the narrow section (20) drills into the coconut (60). The flat section with the large diameter (30) is Tap 2.
Next to the round, flat section with a large diameter (30) is the wide section (50) made from plastic, rectangle-shaped Tap 3 that is equipped with Smooth Wall 1 (1), Smooth Wall 2 (2) and the Upper Smooth Wall (3).
Tap 1, Tap 2 and Tap 3 are together on the same center, functioning as a space for inserting a straw (4) to drink coconut water.

2. The coconut punch tap driller in claim 1 is such that the narrow section (20) is made of metal and the wide section (50) is made of metal.

3. The coconut punch tap driller in claim 1 is such that the weld of the narrow section (20) and the flat section with a large diameter (30) is a thicker part (40) to build strength.

4. The coconut punch tap driller in claim 1 is such that the narrow section (20) and the wide section (50) may either have the same or different lengths.

5. The coconut punch tap driller in claim 1 is such that the narrow section (20) that is Tap 1 is in cylinder shape with a small diameter with a smooth end.
